(19) United States
(12) Patent Application Publication
(10) Pub. No.: US 2010/0305936 A1
(43) Pub. Date: Dec. 2, 2010

(54) METHOD OF OPERATING A COMPUTING DEVICE THROUGH THE USE OF EXTENSIBLE THREAD STATES

(75) Inventor: Dennis May, London (GB)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SYMBIAN SOFTWARE LTD., London (GB)

(21) Appl. No.: 12/063,259

(22) PCT Filed: Aug. 8, 2006
(86) PCT No.: PCT/GB2006/002951

§ 371 Date: Aug. 19, 2010

(30) Foreign Application Priority Data
Aug. 10, 2005 (GB) 0516426

(51) Int. Cl. G06F 9/455

(52) U.S. Cl. 703/23

(57) ABSTRACT

A personality layer running above an operating system kernel puts any threads that the personality layer is responsible for into new states which the kernel does not know about. This prevents the kernel from performing operations on a thread which has been placed in one of these new states where these operations are sensitive to state of the thread itself (such as kill, suspend, change priority). Instead, the kernel redirects these thread operations to a handler in the personality layer which then handles the operation. The kernel is thus, in essence, extensible through the use of the added personality layers, and it can therefore be used to run legacy real-time applications written for other real-time operating systems.

This invention relates to a method for operating a computing device, and in particular to the use of an extended range of thread states in an Operating System (OS) kernel to add new personality layers to a device.

It is advantageous for manufacturers and others who are seeking to implement existing computing technology on new platforms to try to reuse their existing software materials. This is especially true for consumer devices such as mobile telephones, which tend to have a short product life compared to the time invested in their development; any measures which can be taken that shorten the development cycle improves development efficiency, and this reduces overall device cost.

Communications stacks and protocol implementations are good examples of the software material that manufacturers seek to reuse in modern consumer electronic devices. There is an increasing trend for such devices to converge, and hence communications and networking capabilities will increasingly be required in many diverse situations. Such software materials tend to have the following features in common:
they are large complex pieces of software in which the phone manufacturer concerned has made a considerable financial investment
they have significant real time requirements
they have generally been developed to run over some type of real-time operating system (RTOS). These include both proprietary systems and standard commercial systems such as Nucleus Plus, VRTX or OSE.

Such software has been referred to as a legacy real time application (LRTA).

There are a number of ways of incorporating an LRTA on to a new device platform.

A relatively straightforward method is to run the LRTA components on their own CPU, separate from the one that handles the remaining functionality for the device. There are some advantages to this solution: the LRTA need not be modified and the fact that it is completely isolated from the remainder of the software on the new device reduces the integration burden.

However, there are also disadvantages to this method: the most notable ones are the cost of the extra processor and the increase in physical memory required in the device.

Because of the cost pressures on modern computing devices, and these cost pressures are responsible for the decision to use the LRTA in the first place, it is usually the case that the separate processor solution is rejected as being too expensive. This necessarily means that the LRTA must be run on the same CPU as the remainder of the software on the device, and will need to be run under the native operating system (OS) for that CPU. Those skilled in the art will be aware that there are three principal ways of achieving this:
1. Modify the source code (and possibly design) of the LRTA to run directly under the native OS for the CPU. Because the LRTA is typically made up of relatively low level components, this will normally be achieved by re-engineering the LRTA either as a purely kernel-mode device driver, or as a combination of kernel and user mode components. However, this option is also commercially unrealistic because of the time taken to modify the LRTA, the risk involved in doing so and the problem of creating a second distinct version of the LRTA that then increases the ongoing maintenance burden for the device manufacturer.
2. Implement a system in which both the native OS and the LRTA RTOS run concurrently. This can be achieved either by placing hooks into the CPU native OS kernel at strategic places (interrupt and possibly other exception vectors) to allow the RTOS to run, or by implementing some kind of “hypervisor” that performs context switches between the two operating systems. This requires modifications to both operating systems to make calls to the hypervisor to indicate thread switches, priority changes and so on.

However, this second option also has its problems. Performance is degraded because of the hooks that are called on every interrupt and every executive call, even if they are not related to the LRTA. The hypervisor system will degrade performance even more due to the presence of more hooks and a whole extra layer of processing on interrupts. Also, the hooks add additional complication and risk of defects to particularly sensitive areas of code. Moreover, inserting hooks into the native OS kernel to allow the RTOS to run whenever it wants to destroys its real time performance, since a low priority thread in the LRTA will take precedence over a high priority thread in the native OS. The hypervisor system does not necessarily suffer from this problem but is considerably more complicated and incurs a larger performance penalty. Additionally, the hooks become extremely complicated and hard to manage if more than one RTOS needs to be integrated onto the device; this could be necessary, for example, if both a GSM signaling stack and a Bluetooth stack are required and each uses a different RTOS.
3. Implement a personality layer over the native OS kernel, which provides the same application programming interface (API) as the original RTOS, or at least as much of it as is required by the LRTA. The RTOS itself can then be dispensed with and the LRTA can run using the native OS kernel as the underlying real time kernel (assuming of course that is has the capability).

The use of a personality layer is the preferred solution to the problem, and this invention is directed to the provision of such a solution.

However, current methods of implementing personality layers are not able to handle multiple personalities in real-time. This invention proposes a method of achieving this real time operation.

According to a first aspect of the present invention there is provided a method of implementing a personality layer for a first operating system on a computing device running a second operating system which enables software written for the said first operating system to run on the device by means of
a. the addition of extra states to the threads of execution running on the computing device by the personality layer; and
b. the kernel of the second operating system dispatching threads which are in these extra states to a handler in the personality layer.

According to a second aspect of the present invention there is provided a computing device arranged to operate in accordance with a method of the first aspect.

According to a third aspect of the present invention there is provided an operating system for causing a computing device to operate in accordance with a method of the first aspect.

Embodiments of the present invention will now be described, by way of further example only, with reference to the accompanying drawings in which;—

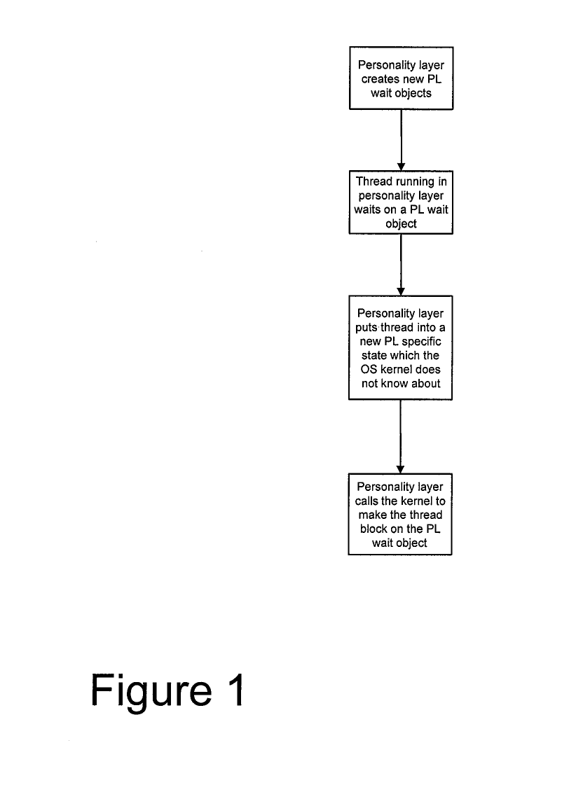

FIG. 1 shows an embodiment of the present invention for extending kernel operability by handling thread states through the use of a personality layer; and

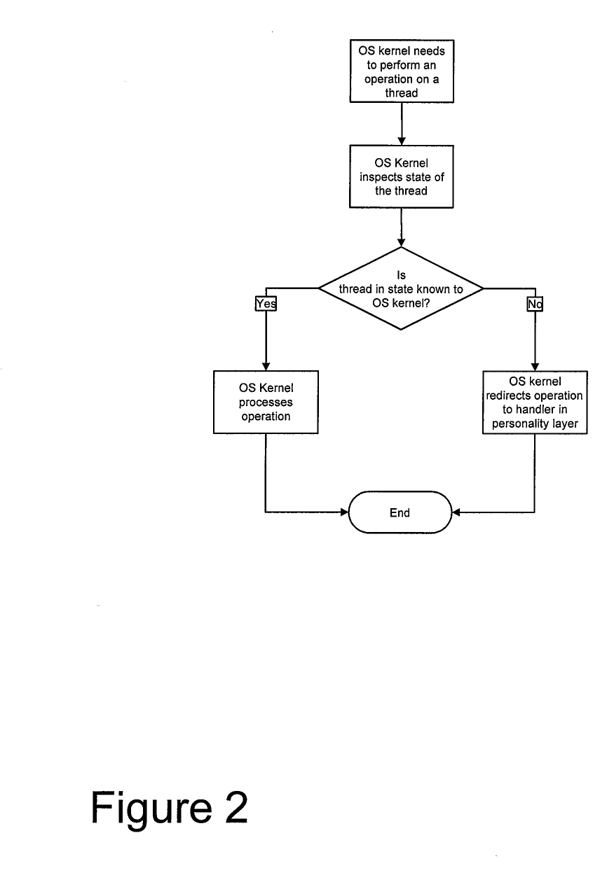

FIG. 2 shows the operation for directing a thread to the personality layer.

This invention makes the kernel extensible, and by making it possible to add additional thread states, it enables the development of personality layers (PL). A personality layer may be regarded as a layer that sits on top of the kernel and emulates another operating system's APIs for use by an already existing application.

An embodiment of the invention may operate as follows:

Referring to FIG. 1, a PL is arranged to create additional wait objects (including but not limited to semaphores, message queues, and event flags) for which threads can wait. When a thread waits on one of these new wait objects, the PL puts the thread into a new PL specific state which the kernel does not know about. Thus the kernel cannot itself perform operations on the thread which are sensitive to its state (such as kill, suspend, change priority) if the thread is in one of these new states so the PL calls the kernel to make the thread block on the PL wait object. This process is shown in FIG. 1.

When the OS kernel requires, however, to perform an operation on a thread the OS kernel inspects the state of the thread. If the thread is in a state known to the kernel, the OS kernel processes the operation defined by the thread. However, if the thread is in a state which is not known to the kernel, the kernel redirects the operation to a handler in the PL. Hence, the operations are redirected to a handler in the PL that processes the situation. The kernel is thus extended because through the provision of the added personality layer it can be used to run a LRTA written for another RTOS. This procedure is shown in FIG. 2.

A detailed example in relation to the Symbian OS EKA2 Nanokernel will now be explained. This will be readily understandable to those skilled in the art of Symbian OS operating system programming:

The nanokernel does not support most of the synchronisation and communication primitives provided by standard Real Time Operating Systems. Therefore, any such primitives required by the LRTA (Legacy Real-Time Application) need to be implemented in the personality layer. This basically means that the personality layer itself is required to define new types of objects on which threads may wait. This in turn requires that new N-states (see below) are defined to signify that a thread is waiting on an object of a new type; generally each new type of wait-object will require an accompanying new N-state. Therefore, to make a thread actually block on a new type of wait object, the following nanokernel function may be used:
void NKern::NanoBlock(TUint32 aTimeout, TUint aState, TAny* aWaitObj);
   The nanothread lifecycle and nanothread N-states may be defined as follows:
   A nanokernel thread can be in one of several states, enumerated by NThreadState and determined by the NThread's iNState member data. Some of these states will now be described:
   iNState==Eready: Threads in this state are eligible for execution. They are linked into the ready list. The highest priority EReady thread is the one that will actually execute at any given time, unless it is blocked on a fast mutex.

iNState==Esuspended: A thread in this state has been explicitly suspended by another thread rather than blocking on a wait object.

iNState==EwaitFastSemaphore: A thread in this state is blocked waiting for a fast semaphore to be signaled.

iNState==EwaitDfc: The thread is a DFC-handling thread and it is blocked waiting for a DFC to be added to the DFC queue that it is servicing. (A DFC is a Delayed Function Call, which is the mechanism used in the OS to enable user mode actions to be triggered by interrupts).

iNState==Esleep: A thread in this state is blocked waiting for a specific time period to elapse.

iNState==Eblocked: A thread in this state is blocked on a wait object implemented in a layer above the nanokernel. This generally means it is blocked on a semaphore or mutex.

iNState=Edead: A thread in this state has terminated and will not execute again.

It should be noted that if a personality layer is being created then it is possible to allow for the nanothreads to have extra states; that is the iNState will be able to take a value other than those above. To achieve this an iStateHandler may be provided in the NThread, and then the kernel is arranged to call this function if there is a transition in state for this nanothread—if it is resumed, blocked and so on.

Thus, this invention enables multiple personality layers to be implemented in real-time, which in turn facilitates the porting of existing real-time software to new devices, reducing device development time.

This invention may, therefore, be summarised as follows. A personality layer running above an operating system kernel puts any threads that the personality layer is responsible for into new states which the kernel does not know about. This prevents the kernel from performing operations on a thread which has been placed in one of these new states where these operations are sensitive to state of the thread itself (such as kill, suspend, change priority). Instead, the kernel redirects these thread operations to a handler in the personality layer which then handles the operation. The kernel is thus, in essence, extensible through the use of the added personality layers, and it can therefore be used to run legacy real-time applications written for other real-time operating systems.

Although the present invention has been described with reference to particular embodiments, it will be appreciated that modifications may be effected whilst remaining within the scope of the present invention as defined by the appended claims.

1. A method of implementing a personality layer for a first operating system on a computing device running a second operating system which enables software written for the said first operating system to run on the device by means of
a. the addition of extra states to the threads of execution running on the computing device by the personality layer; and
b. the kernel of the second operating system dispatching threads which are in these extra states to a handler in the personality layer.

2. A computing device arranged to operate in accordance with a method as claimed in claim 1.

3. An operating system for causing a computing device to operate in accordance with a method as claimed in claim 1.
